(19) United States
(12) Patent Application Publication
(10) Pub. No.: US 2014/0036807 A1
(43) Pub. Date: Feb. 6, 2014

(54) METHOD AND SYSTEM FOR PROVIDING MULTIPLE SERVICES OVER WLAN

(71) Applicant: Telefonaktiebolaget L M Ericsson (publ), Stockholm (SE)

(72) Inventors: Kaiyuan Huang, Kanata (CA); Stephen G. Rayment, Ottawa (CA); Dinand Roeland, Sollentuna (SE); Stefan Rommer, Vastra Frolunda (SE)

(21) Appl. No.: 13/954,128

(22) Filed: Jul. 30, 2013

Related U.S. Application Data
(60) Provisional application No. 61/677,079, filed on Jul. 30, 2012.

(51) Int. Cl. H04W 76/02

(52) U.S. Cl. CPC H04W 76/021
USPC 370/329

(57) ABSTRACT

A system and method of providing, to a client, access to multiple packet data networks (PDNs), each PDN providing a dedicated PDN connection is disclosed. The client is provided with a number of virtual MAC addresses. Each of the virtual MAC addresses is assigned to a dedicated PDN connection and each dedicated PDN connection is associated with one of the packet data networks. One of the virtual MAC addresses is then delivered via a 4 address MAC frame when the client is communicating with the associated data service. The client may be a Wi-Fi client communicating with the associated data service over a cellular data network.

This application claims priority to U.S. Provisional Patent Appln. No. 61/677,079, filed Jul. 30, 2012, the contents of which are incorporated herein by reference.

### FIELD OF THE INVENTION

The present application relates generally to WLAN access to a cellular network, more specifically, to providing multiple virtual services over a WLAN interface.

### BACKGROUND OF THE INVENTION

A need exists to provide multiple concurrent services over WLAN (Wireless Local Area Network). For example when WLAN is used to provide access to cellular data networks, it is desirable to provide access to multiple PDNs (Packet Data Networks). This capability is currently done on 3G/4G networks where, e.g., IMS (IP Multimedia Subsystem) and Internet access can be simultaneously provided. Each of these services is identified via their APNs (Access Point Name). It is the name of a network, where a network in 3GPP terminology is called Packet Data Network (PDN). In the 3GPP core network, there is a gateway called PGW (Packet Data Network Gateway). This is a PDN GW; i.e. a gateway towards one or more PDNs. Between the UE (User Equipment; e.g., Wi-Fi client) and PGW(s) one or more “PDN connections” are setup. Each PDN connection is a virtual point-to-point link from a UE to a PDN. A UE initiates the setup of a PDN connection. When it does that, it may include an APN. Each PDN connection has one IP address. As each PDN may have its own IP address range, it can occur that two PDN connections to different PDNs get the same IP address. Herein, the term “PDN” may be used for a “PDN connection.” Thus, the IP address spaces for each of the different services may overlap, making IP address resolution of the services impossible. What is needed is a means to provide multiple virtual point-to-point links between the device and one or more PDNs.

Other approaches have been proposed to solve this problem, including running VLANs (Virtual Local Area Networks, e.g., IEEE 802.1Q) over WLAN, and performing tunneling over WLAN (using e.g. GRE—Generic Routing Encapsulation). The approach described below is potentially simpler to implement than the alternatives, reducing device cost and power consumption and the basic frame structure is already implemented in some existing devices.

### SUMMARY OF THE INVENTION

The present invention is directed to alleviating the problems of the prior art. In particular, the present invention proposes to use the IEEE 802.11 WDS (Wireless Distribution System) four-address frame format to segregate multiple virtual services over a single WLAN interface.

According to one aspect of the present invention, a method provides to a client access to multiple packet data network (PDN) connections—preferably over WLAN, each PDN providing a dedicated PDN connection (e.g., Skype, Netflix, etc.), a single PDN capable of providing multiple services. The client (e.g., User Equipment (UE) such as a cell phone) is provided with a number of virtual MAC (Media Access Control) addresses. Each of the virtual MAC addresses is assigned to a dedicated PDN connection and each dedicated PDN connection is associated with one of the PDNs. One of the virtual MAC addresses is then provided via a 4 address MAC frame for the client to communicate with the associated data service. When communicating with a data service via a PDN connection, the virtual MAC address associated with the PDN connection is then included in a 4 address MAC frame.

In a preferred embodiment, the client is a Wi-Fi client, and the Wi-Fi client is communicating with the associated data service over a cellular data network.

According to another aspect of the present invention, apparatus providing to a client, access to a plurality of PDNs, each PDN providing a dedicated PDN connection, includes an Access Point (AP) configured to communicate with (i) the client and (ii) the plurality of PDNs. The AP may be configured to provide the client a plurality of virtual MAC addresses, and to assign each of the virtual MAC addresses to a dedicated PDN connection, where each dedicated PDN connection is associated with one of the PDNs. The AP is further configured to provide one of the virtual MAC addresses via a 4 address MAC frame for the client to communicate with the associated data service. In alternative embodiments, the virtual MAC addresses may be (i) pre-loaded onto the UE (User Equipment, e.g., a cell phone) as pre-configured global MACs (e.g., for each data service), (ii) administered by the network (fixed or 3GPP (3rd Generation Partnership Project) AAA (Authentication, Authorization and Accounting protocol)) and sent to UE at authentication, and/or (iii) negotiated dynamically when the UE needs it (e.g. based on ARP (Address Resolution Protocol)). In alternatives (ii) and (iii), the virtual MAC addresses may be supplied to the UE through the AP.

According to a further aspect of the present invention, at least one computer-readable, non-transitory medium is provided, which contains program code which, when loaded into one or more processors of an AP, causes the one or more processors to provide to a client access to a plurality of PDNs, where each PDN provides a dedicated PDN connection. The program code causes the one or more processors to provide the client a plurality of virtual Media Access Control (MAC) addresses; where each of the virtual MAC addresses corresponds to a dedicated PDN connection, each dedicated PDN connection being associated with one of the PDNs; and deliver one of the virtual MAC addresses via a 4 address MAC frame for the client to use when the client is communicating with the associated data service.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

FIG. 1a is a diagram illustrating the general 802.11 frame format;

FIG. 1b is a diagram illustrating the 802.11 frame format in accordance with the preferred embodiments;

FIG. 2 is a diagram illustrating a typical use of the known 802.11 address format frame in a wireless bridge;

FIG. 3 is a block diagram illustrating links between a UE and a Trusted WLAN Access Gateway (TWAG) according to an embodiment of the invention;

FIG. 4 is a is a schematic block diagram of the structure according to the preferred embodiments;

FIG. 5 is a functional flow chart illustrating how the four-address MAC header is used for communication between a UE and a PDN;

FIG. 6 is a flow chart of a preferred process according to the present invention;

FIG. 7 is a process diagram of an initial attachment in WLAN on GTP (GPRS Tunneling Protocol) S2a;

FIG. 8 is a process diagram of UE-Initiated connectivity to additional PDN in WLAN on GTP S2a;

FIG. 9 is a process diagram of a handover procedure between 3GPP access and WLAN on S2a;

FIG. 10 is a process diagram of a handover from WLAN on GTP S2a to 3GPP access;

FIG. 11 is a process diagram of a UE/TWAN-initiated PDN disconnection procedure with GTP S2a in WLAN;

FIG. 12 is a process diagram of a PDN GW Initiated Bearer Deactivation with GTP on S2a.

### DETAILED DESCRIPTION OF THE EMBODIMENTS

In order to lighten the following description, the following acronyms will be used herein:

TABLE 1

| | |
|---|---|
| 3GPP | 3rd Generation Partnership Project |
| AAA | Authentication, Authorization and |
| | Accounting protocol |
| AKA | Authentication and Key Agreement |
| AMBR | Aggregate Maximum Bit Rate |
| AP | Access Point |
| APN | Access Point Network |
| ARP | Address Resolution Protocol |
| BNG | Broadband Network Gateway |
| BSSID | Basic Service Set Identifier |
| DA | Destination Address |
| DHCP | Dynamic Host Control Protocol |
| EAP | Extendible Authentication Protocol |
| EPC | Evolved Packet Core |
| EPS | Evolved Packet System |
| FFS | For Further Study |
| GPRS | General Packet Radio Service |
| GSM | Global System for Mobile |
| | communications |
| GTP | GPRS Tunneling Protocol |
| hPCRF | Home network Policy Control and |
| | Charging Rules Function |
| HPLMN | Home Public Land Mobile Network |
| IMSI | International Mobile Subscriber Identity |
| IP-CAN | IP Connectivity Access Network |
| LBO | Local Breakout |
| MAC | Media Access Control |
| NSWO | Non Seamless WLAN Offload |
| PCEF | Policy and Charging Enforcement |
| | Function |
| PCRF | Policy and Charging Rules Function |
| PDN | Packet Data Network |
| PMIPv6 | Proxy Mobile IP version 6 |
| QoS | Quality of Service |
| RA | Receiver Address |
| S2a | Trusted non-3GPP interface to EPC |
| SA | Source Address |
| SaMOG | S2a-based Mobility over GTP |
| SDO | Standard Development Organization |
| TA | Transmitter Address |
| TEID | Tunnel Endpoint ID |
| TWAG | Trusted WLAN Access Gateway |
| UE | User Equipment |
| vPCRF | Visited network Policy Control and |
| | Charging Rules Function |
| VPLMN | Visited Public Land Mobile Network |
| WDS | Wireless Distribution System |
| WLAN | Wireless Local Area Network |
| WLCP | WLAN Control Protocol |

In overview, the present invention proposes a solution for SaMOG (S2a-based Mobility over GTP) phase 2. For the first PDN connection, additional information elements are proposed to be added to EAP-AKA (Extendible Authentication Protocol-Authentication and Key Agreement). These information elements may carry e.g. handover indicator or APN. For additional PDN connections, traffic may be separated on a per-PDN connection basis using four MAC addresses in the 802.11 frame. A control protocol may be used to setup and teardown additional PDN connections.

Typically, the first PDN/NSWO (Non Seamless WLAN Offload) connection over WLAN uses the per-UE point-to-point link as defined in TS 23.402 clause 16. Standard IEEE 802.11 messaging is used over the Wi-Fi air link. As defined in IEEE 802.11-2007 section 7.2.2, a normal data frame uses three address fields. E.g. for an uplink frame (To DS=1 and From DS=0 in table 7-7 of IEEE 802.11-2007):
Address #1 is the receiving address (RA) and equals the BSSID of the AP;
Address #2 is the transmitting address (TA) and equals the source address (SA) which equals the MAC address of the UE;
Address #3 is the destination address (DA) and equals the MAC address of the TWAG (Trusted WLAN Access Gateway).
The MAC header also defines an address #4 which is normally not used.

To achieve a per-UE-and-PDN point-to-point link for additional PDN/NSWO connections, all four address fields in the MAC data frame header are used in accordance with the present invention. Frames are sent/received with header fields To DS=1 and From DS=1 as defined in table 7-7 of IEEE 802.11-2007. E.g. for an uplink frame:
Address #1 is RA and equals the BSSID of the AP;
Address #2 is TA and equals the physical MAC address of the UE;
Address #3 is DA and equals the MAC address of the TWAG;
Address #4 is SA and equals a virtual MAC address of the UE.

In the present invention, for each additional PDN connection, there is a virtual MAC address on the UE. This address is preferably unique within the scope of the UE. A virtual MAC address combined with the physical MAC address of the UE provides a globally unique identification for a PDN/NSWO connection. The TWAG and the UE can use this identification to correlate a packet to the correct PDN/NSWO connection.

Preferably, the 4-address MAC frame is used only over the Wi-Fi air link. Between the access point and TWAG, standard (wired) Ethernet frames are used. For an additional PDN connection, the UE virtual MAC address may be used between the access point and TWAG. The solution may be: (1) In the downlink, the AP preferably is able to know which physical MAC belongs to a virtual MAC. This may be a new AP requirement. It may learn this from uplink packets, though. (2) If we the physical MAC is not used between AP and TWAG, but only use the virtual MAC, then the virtual MAC should be unique within the scope of a TWAG. So, some kind of MAC negotiation mechanism can be used. This could be done with the control protocol in the next section. Alternatively, some other mechanism e.g. VLANs between AP and TWAG may be used.

WLCP (WLAN Control Protocol) is a new protocol (related to SaMOG). The details are to be defined in Wi-Fi Alliance or 3GPP. WLCP could use the 4-address field as well; e.g. a dedicated virtual MAC is used to denote WLCP packets. The WLCP packets may be defined by Wi-Fi Alliance or stage 3 in 3GPP. A WLCP packet may e.g. indicate “attach” including APN and handover indicator.

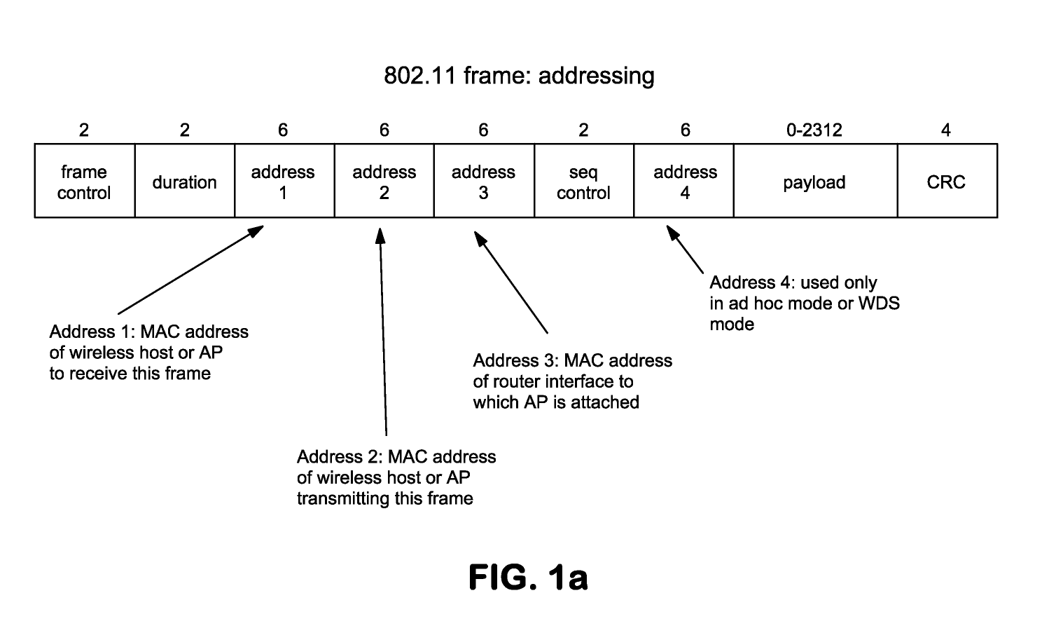

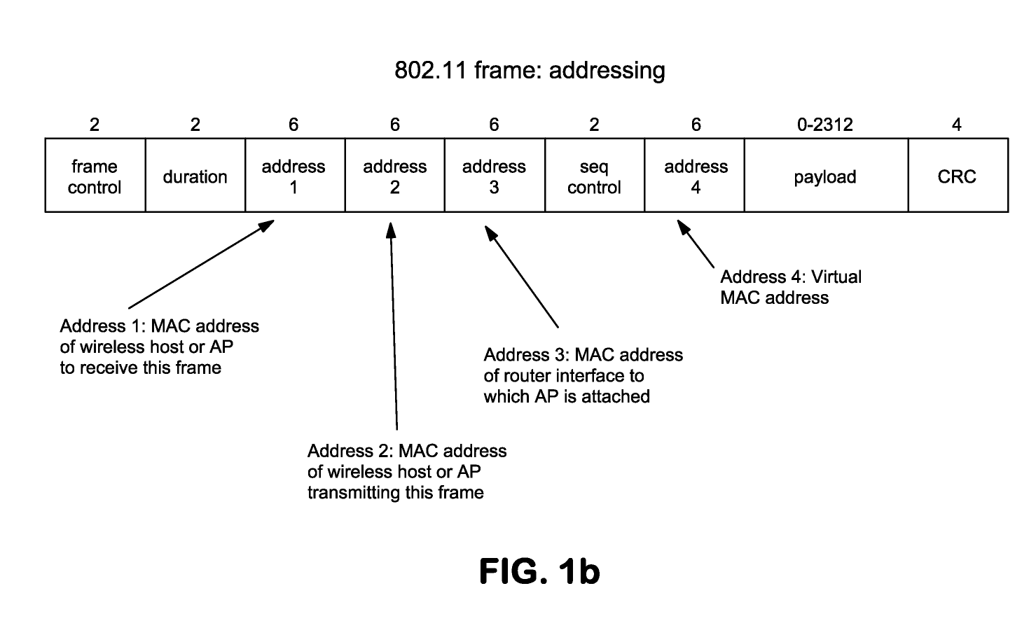

FIG. 1a, is a diagram which illustrates the general format of the 802.11 MAC frame format. The MAC frame format comprises a set of fields that occur in a fixed order in all frames. There are three address fields in the MAC frame format, four when the ad hoc or the Wireless Distribution System (WDS) mode is being used. These fields are used to indicate the basic service set identifier (BSSID), source address, destination address, transmitting station address, and receiving station address. The usage of the four address fields in each frame type is indicated by the abbreviations BSSID, Destination Address (DA), Source Address (SA), Receiver Address (RA), and Transmitter Address (TA).

FIG. 1b, is a diagram which illustrates the format of the 802.11 4-address MAC frame format according to the preferred embodiments. It is similar to FIG. 1a, but specifies that the fourth MAC address is a virtual MAC address.

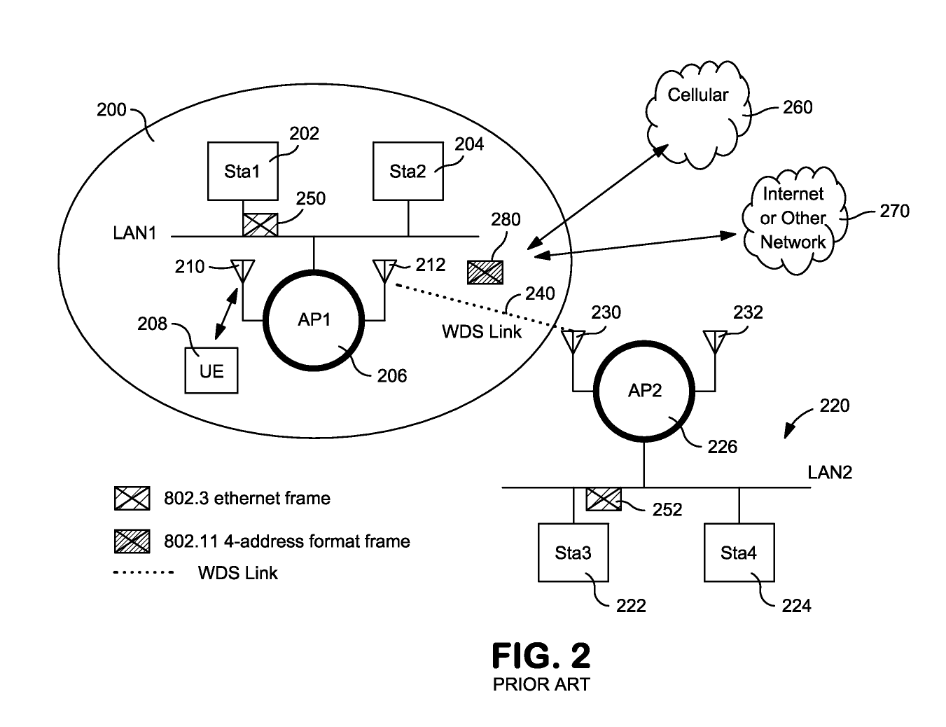

In FIG. 2, a LAN 1 (200) has a Station 1 (202), a Station 2 (204), an AP 1 (206), and UE (208), which communicates with at least one of antennas (210) and (212). A second LAN 2 (220) has a Station 3 (222), a Station 4 (224), an AP 2 (226), and antennas (230) and (232). LAN 1 communicates with LAN 2 over WDS link (240), using an 802.11 4-address format frame (280) according to the ad hoc or WDS modes. LAN 1 and LAN 2 operate with 802.3 Ethernet Frames (250) and (252), respectively. LAN 1 can communicate with a cellular network (260) and/or an Internet or other network (270). Each of the Stations, APs, and UEs includes one or more processors, ROM storing program code for carrying out the functions described herein, RAM, typical interfaces, transmitters/receivers, antennas, power supplies, etc. The UE may, for example, be a hand-held portable device such as a cellular telephone, smart phone, pad device, Personal Data Assistant, laptop computer, etc.

In FIG. 2, the four-address format frame (280) may be used to direct information over the WDS link (240). In this case, the four-address format frame (280) comprises the MAC address of Station 1 (202), the MAC address of Access Point 1 (206), the MAC address of Access Point 2 (226), and the MAC address of Station 3 (222). These are included in the 802.11 frame header. The frame data of (280) is the same as the original Ethernet frame (250). Based on information in this four-address format frame (280), the original Ethernet frame (250) will be reconstructed.

In the prior art, the UE typically can have only a single connection over the WLAN. The UE will not be able to concurrently access more than one PDN connection. As indicated earlier, when the WLAN is used to provide access to cellular data networks, it is desirable to provide access to multiple PDNs (packet data networks). As will be described further below, in the preferred embodiments, the IEEE 802.11 WDS (Wireless Distribution System) four-address frame format (280) is used to segregate multiple virtual services over a single WLAN interface. A four-address format currently may be used to create wireless repeater products, where one pair of addresses defines the ultimate source and destination address, and the other pair defines the next hop address. In the preferred embodiments on the other hand, the format is modified to enable multiple virtual services to be associated with multiple virtual addresses.

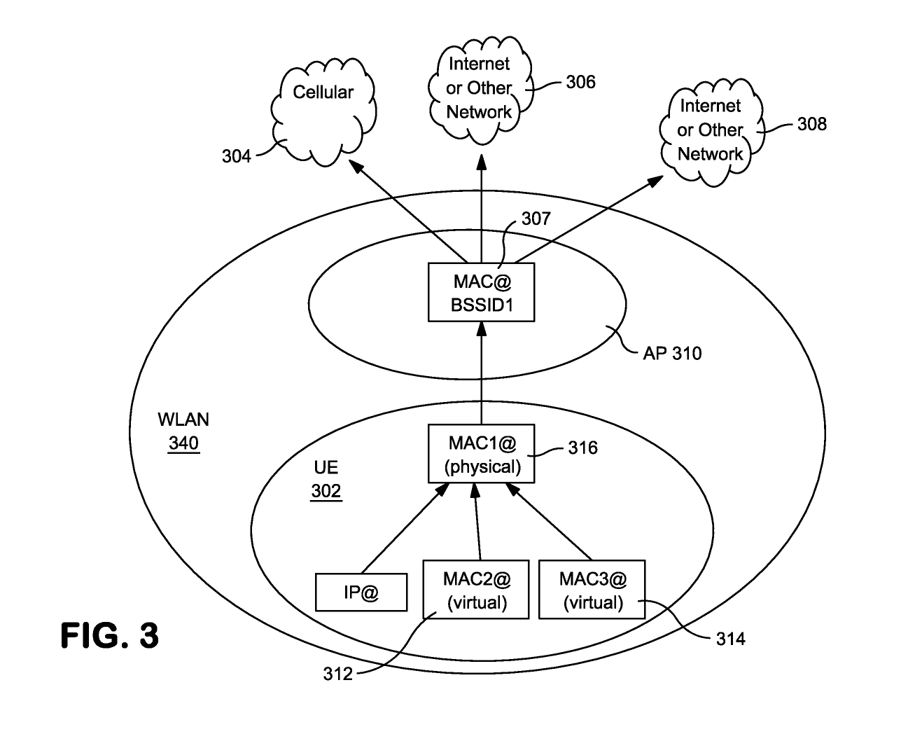

FIG. 3 shows the basic architecture of a wireless distribution system that illustrates how a UE can access multiple services according to the preferred embodiments of the present invention. In FIG. 3, MAC2@ and MAC3@ each are associated with an IP@. Thus, there are a total of three IP addresses in FIG. 3. The figure illustrates how a Wi-Fi client, such as a mobile device UE (302) can connect to a Trusted WLAN Access Gateway Cellular Network (304), or Internet or other network (306) and/or (308), via an Access Point (310) in order to obtain access to additional services through the WLAN 340.

The Wi-Fi client (302) is provided access to multiple packet data networks (PDNs) via a cellular data network (304), where each PDN provides a dedicated PDN connection. More specifically, the Wi-Fi client (302) is provided with a number of virtual MAC addresses (312) and (314). Each virtual MAC address (312) and (314) is assigned to a dedicated PDN connection and each dedicated PDN connection is associated with one of the packet data networks. The Wi-Fi client's virtual MAC address for the requested data service is then delivered via a 4 address MAC frame (inner address) when the Wi-Fi client (302) is communicating with the associated data service over the cellular data network (304).

For an upstream frame (device to network), the receiver address is the wireless access point (310) address MAC BSSAD1 (307; outer address), and the destination address is the wireless access gateway address, while the transmitter address is the device (302) physical address (316) and the source address is the device (302) virtual address (312; inner address) and/or (314; inner address). For a downstream frame (network to device), the transmitter address is the access point (310) address and the source address is the wireless access gateway, while the receiver address is the device (302) physical address (316) and the destination address is the device (302) virtual address (312) and/or (314).

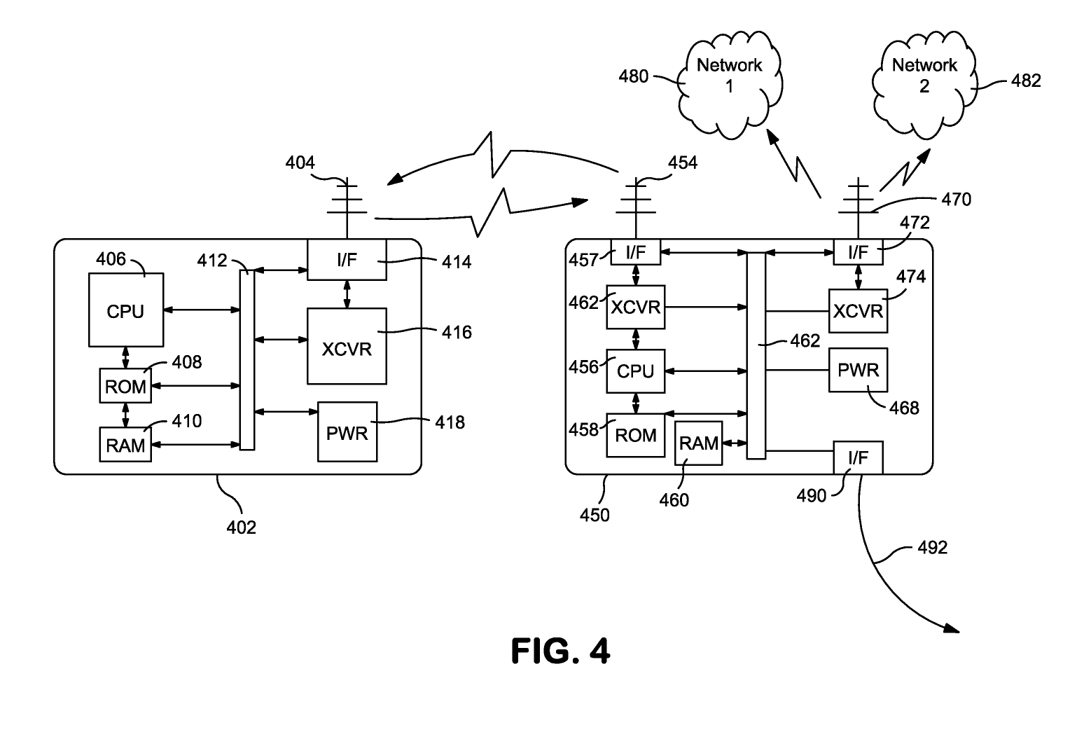

FIG. 4 is a is a schematic block diagram of the structure according to the preferred embodiments. The UE may comprise a cellular telephone (402) having an antenna (404) which wirelessly communicates with a first antenna (454) of an AP (450). The cellular telephone (402) also has one or more CPUs (406), a ROM (408), a RAM (410), a bus (412), an antenna interface (414), a transmitter/receiver (416; which may be separate or combined circuitry), and a power supply (418). The AP has a one or more CPUs (456), a ROM (458), a RAM (460), a bus (462), a first antenna interface (456), a first transmitter/receiver (462; which may be separate or combined circuitry), and a power supply (458). The AP (450) also has a second antenna (470) for communicating with one or more dedicated Networks (480) and (482). A second interface (472) is coupled the second antenna (470), and a second transceiver (474) is coupled to the second interface (472). A third interface (490) may, for example, be coupled to a wired network via wiring (492).

For single APN connections, only the transmitter address and the receiver address will be used on the upstream and downstream respectively. The need to use multiple PDN connections is indicated when the device initially connects to the network, or when an additional APN is needed, by using, e.g. extensions to EAP (Extensible Authentication Protocol) or DHCP (Dynamic Host Control Protocol). In this case the source and destination address fields will be used instead of transmitter and receiver.

For a first PDN connection, the normal Wi-Fi MAC address format is used. No change is necessary compared to unmodified UE. The 4-MAC address MAC format is then used between UE and AP for additional PDN connections. The 4-MAC frame in the upstream, i.e. between UE and AP will comprise:
RA (Receiver Address)=AP BSSID
TA (Transmitter Address)=UE MAC@1 (physical)
DA (Destination Address)=TWAG
SA (Source Address)=UE MAC@2 (virtual; for 2nd PDN connection).

On the downstream side, that is between the AP and UE, the 4-MAC frame format will comprise:
RA (Receiver Address)=UE MAC@1 (physical)
TA (Transmitter Address)=AP BSSID
DA (Destination Address)=UE MAC@2 (virtual)
SA (Source Address)=TWAG.
Where, e.g., MAC@1 is an abbreviation for MAC Address 1.

Now, between the AP and the TWAG, normal addressing is used; e.g. using UE MAC@2 for the 2nd PDN connection. The virtual MAC addresses may assigned to the UE by:
Pre-configured global MACs loaded into the UE at the factory or a UE provisioning facility (e.g., wireless provider store);
Administered by a network (fixed or 3GPP (AAA) and sent to the UE at authentication (perhaps limited to a max number of PDN connections); and/or
Negotiated dynamically when the UE needs it (e.g. by means of the previously mentioned WLCP, or based on ARP (Address Resolution Protocol)).

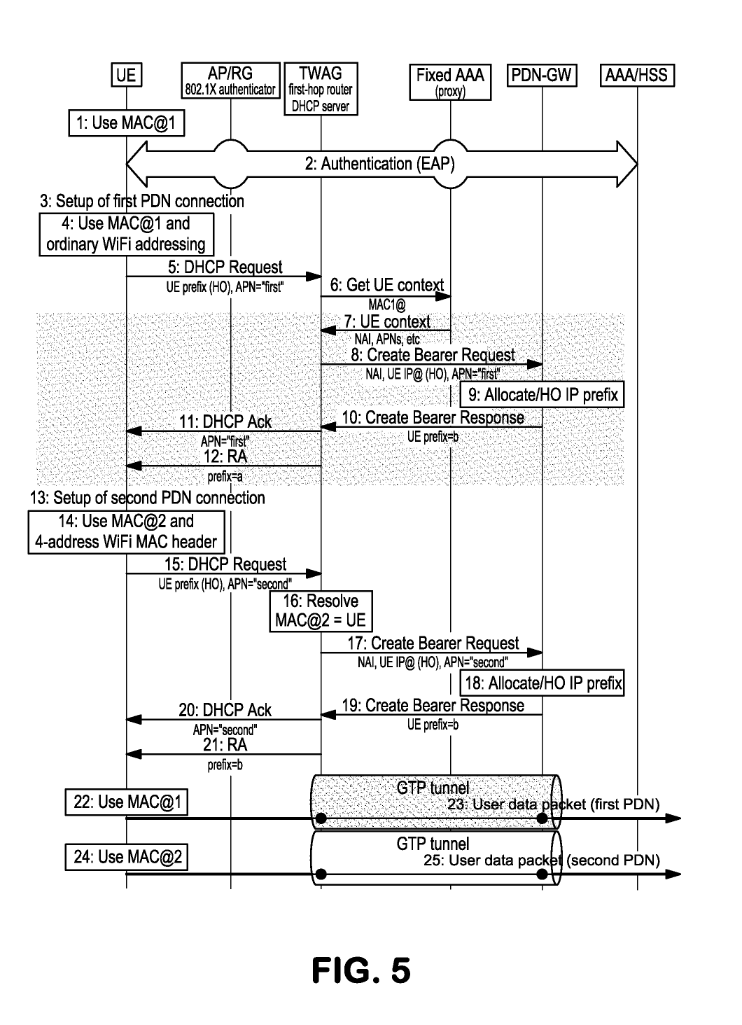

FIG. 5, is a functional flow diagram illustrating how the 4-address MAC header is used in the establishment of an additional PDN connection in the preferred embodiments.

For authentication (EAP and 802.1X) and for the first PDN connection, the UE uses its first MAC address and normal Wi-Fi MAC frame for addressing. This way, an easier UE implementation can be achieved when only a single PDN connection is used.

For an additional PDN connection, the UE uses another virtual MAC address. All signaling over Wi-Fi is done using the 4-address MAC frame. For PDN connections, DHCP extensions may be used (when DCHP is the control plane protocol) to indicate handover and a non-default APN. Downlink frames are always sent L2 (Layer 2) unicast (including e.g. RA and IP multicast). The 4-address MAC frames use the same encryption over Wi-Fi as the normal MAC frames.

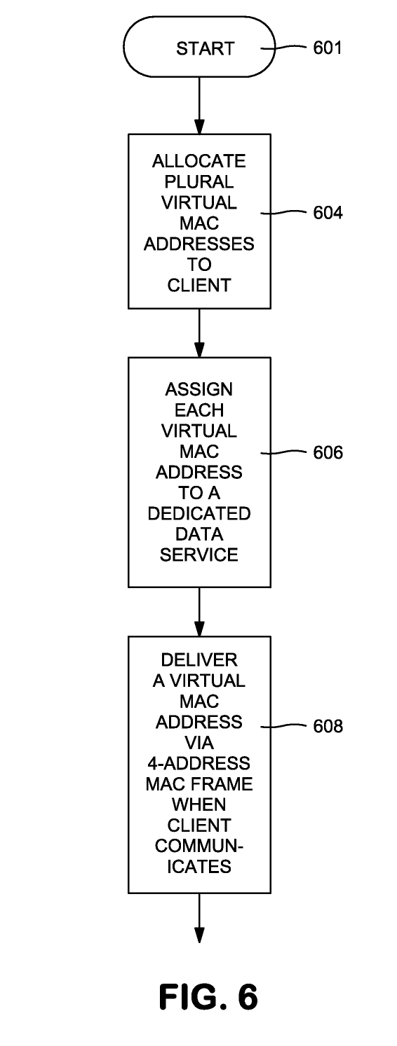

FIG. 6 is a flow chart of a preferred process according to the present invention. These functions are preferably carried out in the AP, using one or more processors therein, together with memory storing program code to carry out the described functions. The process provides the UE access to a plural PDNs, where each PDN provides a dedicated PDN connection. The process begins at step (602), and at step (604) the AP allocates the UE a plurality of virtual MAC addresses. At step (606), the AP assigns each of the virtual MAC addresses to a dedicated PDN connection, each dedicated PDN connection being associated with one of the PDNs. At step (608), the AP delivers one of the virtual MAC addresses via a 4 address MAC frame when the UE is communicating with the associated data service.

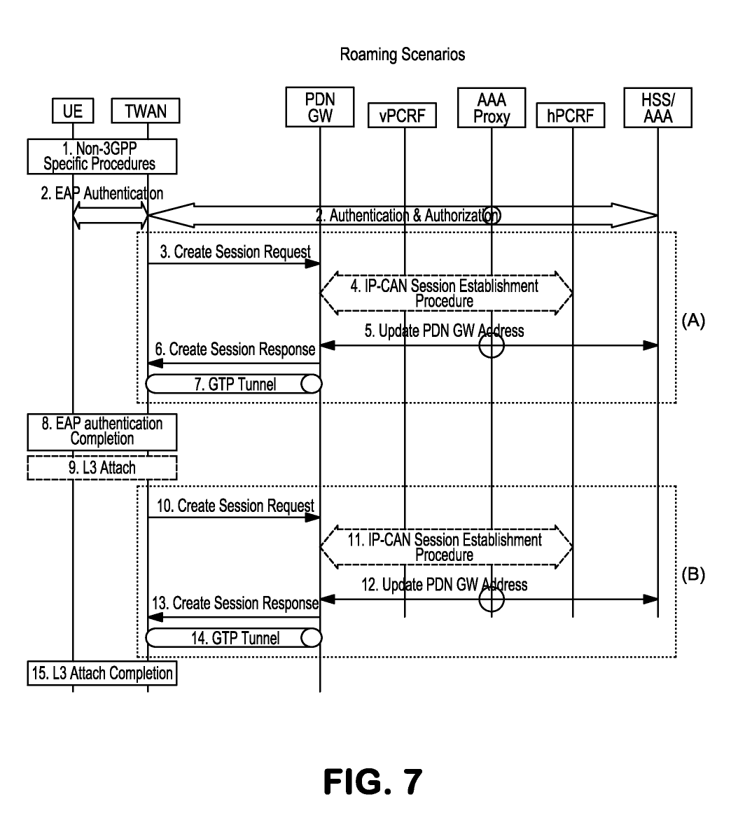

FIG. 7 is a process diagram of an initial attachment in WLAN on GTP (GPRS Tunneling Protocol) S2a for roaming, LBO (Local Breakout), and non-roaming scenarios. The procedure is as in 3GPP TS (Technical Specification) 23.402 clause 16.2.1 with the following additions:
Step 1. Optionally, in order optimize network selection, the network may indicate its capabilities (support for handover, support for attach to non-default APN, support for non-seamless WLAN offload, support for EPC-routed traffic, support for attach to multiple PDN connections). Preferably, it is FFS if these capabilities are specified by 3GPP or by another SDO.
Step 2. The UE indicates initial attach in EAP to the 3GPP AAA. The UE preferably indicates whether it requests EPC (Evolved Packet Core) access or non-seamless WLAN offload in EAP to the 3GPP AAA. If the UE requests EPC access, it may indicate APN. As part of step 2, the 3GPP AAA sends these indicators to the TWAN. If the UE indicates EPC access without indicating APN, then the EAP reply indicates the selected default APN. As part of step 2, the UE indicates its capabilities (support for handover, support for attach to non-default APN, support for attach to multiple PDN connections). The network indicates its capabilities (support for handover, support for attach to non-default APN, support for non-seamless WLAN offload, support for EPC-routed traffic, support for attach to multiple PDN connections) to the UE.
Step 3. If the UE indicated an APN in the previous step, the TWAN verifies that it is allowed by subscription, selects the PDN GW for the APN correspondingly, and includes the APN in the Create Session Request.

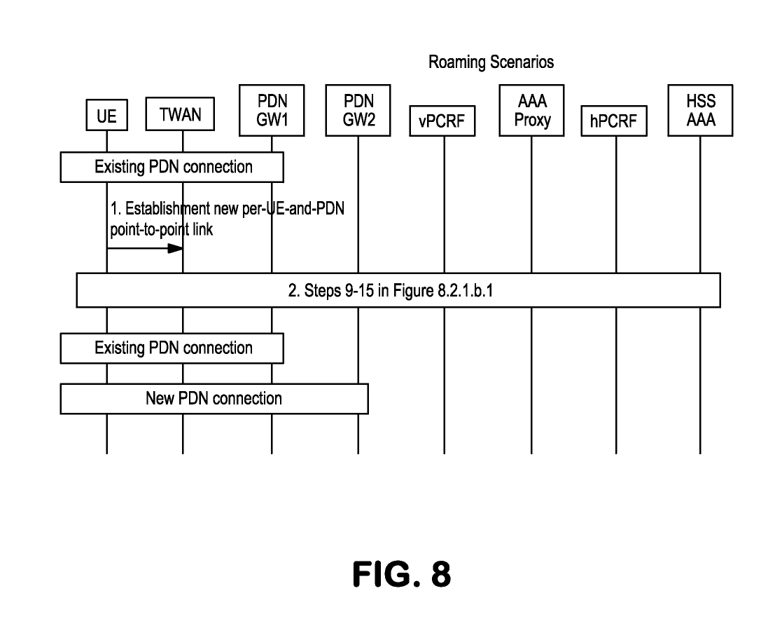

FIG. 8 is a process diagram of UE-Initiated connectivity to an additional PDN in WLAN on GTP S2a. Establishment of an additional PDN/NSWO connection over WLAN with GTP S2a is supported only for the accesses that support such feature and for the UEs that have such capability.

This procedure is related to the case when the UE has an established a PDN/NSWO connection over WLAN and wishes to establish one or more additional PDN/NSWO connections over such access. This procedure is also used to request for connectivity to an additional PDN/NSWO connection over WLAN when the UE is simultaneously connected to such access and a 3GPP access, and the UE already has active PDN/NSWO connections over both the accesses. The UE establishes a separate point-to-point link to the TWAG for each additional PDN/NSWO connection.

There can be more than one PDN connection per APN when GTP is used between the TWAN and the PDN GW. During the establishment of a new PDN connection, the TWAN allocates and sends a default S2a bearer ID to the PDN GW. The default S2a bearer ID is unique in the scope of the UE within a TWAG, i.e. the IMSI (International Mobile Subscriber Identity) and the default S2a bearer ID together identify a PDN connection within a TWAG. In order to be able to identify a specific established PDN connection, both the TWAG and the PDN GW preferably store the default S2a bearer ID. The establishment of an additional PDN/NSWO connection should not impact the first PDN/NSWO connection. As a separate point-to-point link is used for each additional PDN/NSWO connection, traffic separation can be achieved between all PDN/NSWO connections including the first.
Step 1. The UE triggers the establishment of a new PDN/NSWO connection by means of WLCP. This step establishes the setup of a new per-UE-and-PDN-connection point-to-point link to the TWAG. The UE preferably indicates whether it requests EPC access or non-seamless WLAN offload. If the UE requests EPC access, it may indicate APN. The UE preferably triggers the re-establishment of an existing PDN/NSWO connectivity by providing a handover indicator.
Step 2. Upon establishment of an additional PDN/NSWO connection, steps 9-15 as described in clause 8.2.x.2.1.1 are performed. As part of these steps, the TWAN performs PDN GW selection as described in TS 23.402. Steps 9-15 are preferably executed with PDN GW2 instead of PDN GW1. Unless non-seamless WLAN offload was selected in step 1, steps 10-14 in clause 8.2.x.2.1.1 are preferably always performed.

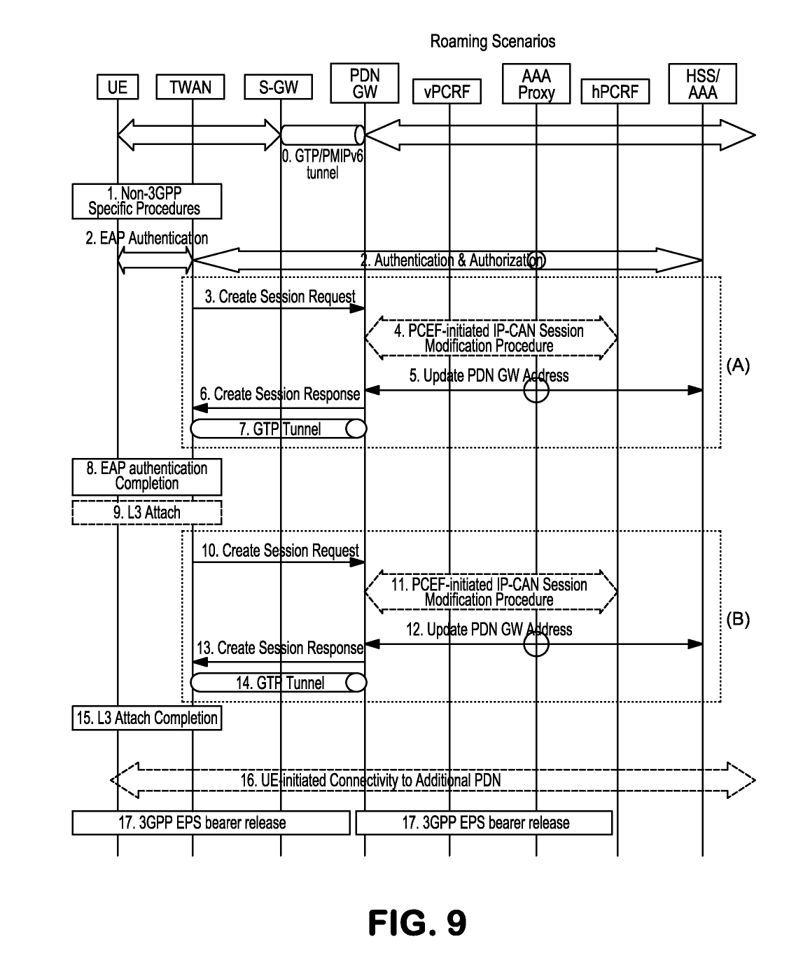

FIG. 9 is a process diagram of a handover procedure between 3GPP access and WLAN on S2a. The home routed roaming, LBO and non-roaming scenarios are depicted in FIG. 9. In the LBO case, the 3GPP AAA Proxy acts as an intermediary, forwarding messages from the 3GPP AAA Server in the HPLMN (Home Public Land Mobile Network) to the PDN GW in the VPLMN (Visited Public Land Mobile Network) and vice versa. Messages between the PDN GW in the VPLMN and the hPCRF in the HPLMN are forwarded by the vPCRF in the VPLMN. In the home routed roaming and non-roaming cases, the vPCRF and the 3GPP AAA Proxy preferably are not involved, except for the authentication and authorization in step 2.

For connectivity to multiple PDNs the following preferably applies:
If the UE is connected to both 3GPP access and non-3GPP access before the handover of PDN connections to non-3GPP access is triggered, steps 2 to 15 are preferably skipped and the UE preferably only perform step 16 for each PDN connection that is being transferred from 3GPP access.
If the UE is connected only to 3GPP access before the handover of PDN connections to non-3GPP access is triggered, steps 2 to 15 are preferably performed. In these steps the UE preferably provides an APN corresponding to one of the PDN connections that are being transferred from 3GPP access. The UE preferably then repeats step 16 for each of the remaining PDN connections that are being transferred from 3GPP access.
Step 17 is preferably repeated for each PDN connection that is being transferred from 3GPP access.
Step 16 can occur in parallel for each PDN. Other impacts related to the handover for multiple PDNs are described in TS 23.402 clause 8.1.

The steps in FIG. 9 are based on FIG. 8, with the following changes:
Step 0. The UE is connected in the 3GPP Access and has a PMIPv6 or GTP tunnel on the S5/S8 interface.
Step 2. As step 2 in FIG. 8 with the following addition: The UE preferably indicates handover via EAP to 3GPP AAA.
Steps 3 and 10. As step 2 in FIG. 8 with the following addition: The handover indication is preferably set in the Create Session Request to allow the PDN GW to re-allocate the same IP address or prefix that was assigned to the UE while it was connected to the 3GPP IP access and to initiate a PCEF (Policy and Charging Enforcement Function)-Initiated IP-CAN (IP Connectivity Access Network) Session Modification Procedure with the PCRF (Policy and Charging Rules Function).
Step 4 and 11. The PDN GW preferably executes a PCEF-Initiated IP CAN Session Modification Procedure with the PCRF as specified in TS 23.203 [xx]. The Event Report indicates the change in Access Type. If the PDN GW decided to allocate a new IP address/prefix instead of preserving the old IP address/prefix, as described in TS 23.402 clause 4.1.3.2.3, the PDN GW executes an IP-CAN session Establishment Procedure with the PCRF instead of a PCEF-Initiated IP-CAN Session Modification Procedure.
Step 6 and 13. The PDN GW preferably responds with a Create Session Response (PDN GW Address for the user plane, PDN GW TEID (Tunnel Endpoint ID) of the user plane, PDN GW TEID of the control plane, PDN Type, PDN Address, EPS (Evolved Packet System) Bearer Identity, EPS Bearer QoS (Quality of Service), APN-AMBR (Aggregate Maximum Bit Rate), Charging ID, Cause). The Create Session Response preferably contains the IP address and/or the prefix that was assigned to the UE while it was connected to the 3GPP IP access. The Charging Id provided by the PGW is preferably the Charging ID previously assigned to the default bearer of the PDN connection in the 3GPP access.
Step 16. For connectivity to multiple PDNs simultaneously or nearly-simultaneously, the UE preferably establishes connectivity to each PDN that is being transferred from 3GPP access, besides the PDN connection that was established in the previous steps, by executing the UE-initiated Connectivity to Additional PDN procedure specified above.
Step 17. The PDN GW preferably initiates the PDN GW Initiated PDN Disconnection procedure in 3GPP access as defined in TS 23.402 clause 5.6.2.2 or the PDN GW Initiated Bearer Deactivation procedure as defined in TS 23.401 [xx], clause 5.4.4.1.

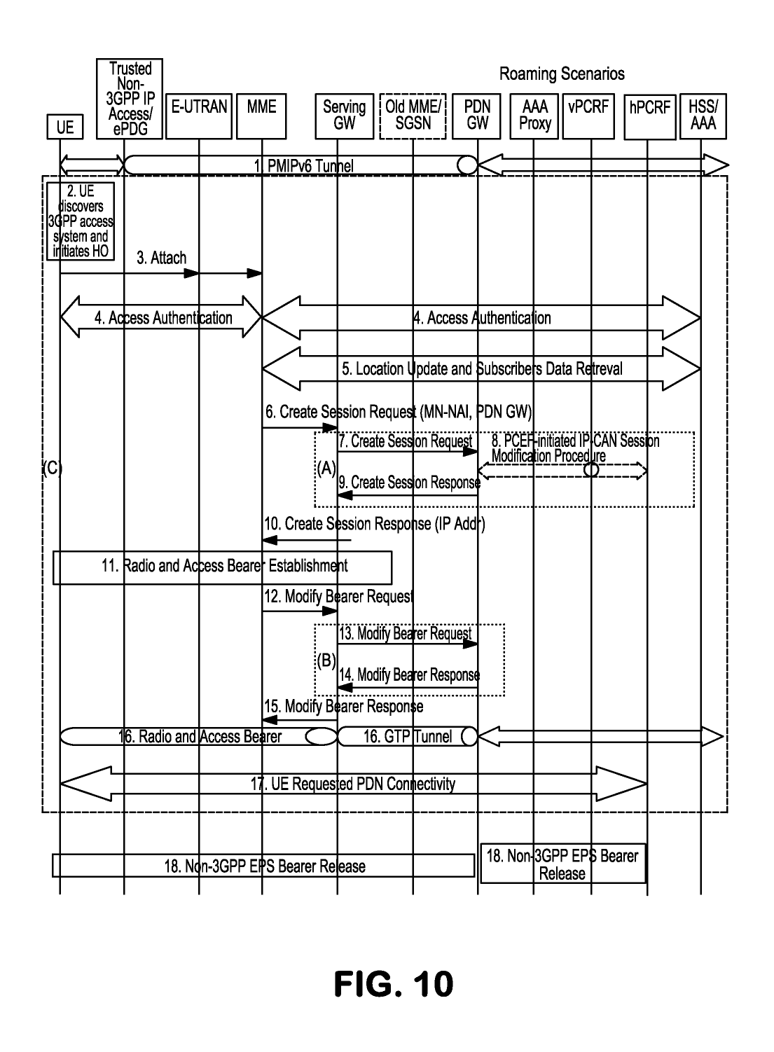

FIG. 10 is a process diagram of a handover from WLAN on GTP S2a to 3GPP access for roaming, LBO and non-roaming scenarios, according to the present invention. This procedure is preferably as in TS 23.402 clause 8.2.1.1/8.2.1.2 with the following differences:
Step 1. There is preferably a GTP tunnel between TWAN and PGW.
Step 18. The PDN GW preferably initiates resource allocation deactivation procedure in the TWAN as discussed above.

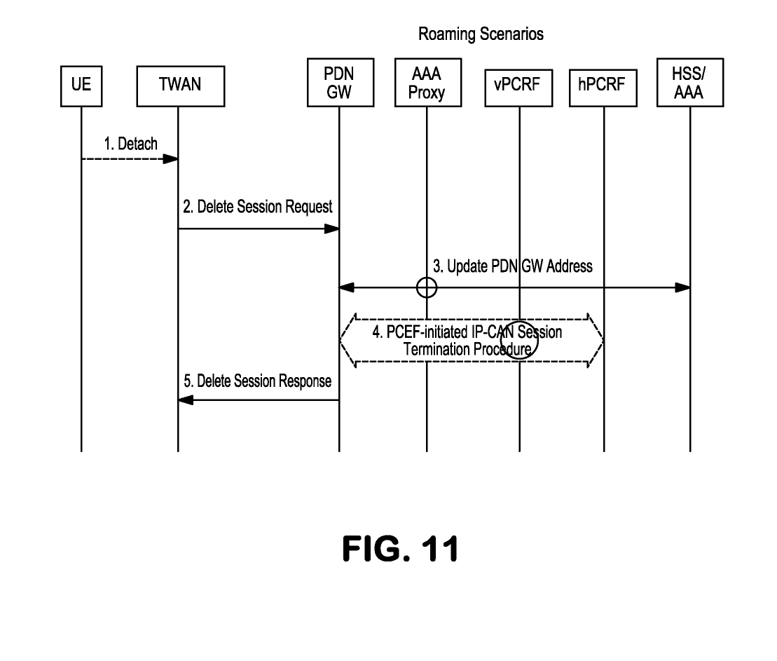

FIG. 11 is a process diagram of a UE/TWAN-initiated PDN disconnection procedure with GTP S2a in WLAN. If the UE has a single PDN/NSWO connection established over WLAN, this procedure is preferably the same as TS 23.402 clause 16.3.1.1. If the UE has multiple PDN/NSWO connections established over WLAN, this clause preferably applies to UE/TWAN-requested PDN disconnection procedure. For multiple PDN/NSWO connectivity, this disconnection procedure is preferably repeated for each PDN/NSWO connection.

The procedure outlined in FIG. 11 preferably applies to the Non-Roaming, Home Routed Roaming, and Local Breakout cases. In the Local Breakout case, the vPCRF preferably forwards messages between the PDN GW and the hPCRF. In the Home Routed Roaming and LBO cases, the 3GPP AAA Proxy preferably serves as an intermediary between the Trusted Non-3GPP IP Access and the 3GPP AAA Server in the HPLMN. In the non-roaming and Home Routed Roaming case, the vPCRF is preferably not involved.

If dynamic policy provisioning is not deployed, the optional steps of interaction between the PDN GW and PCRF preferably do not occur. Instead, the PDN GW may employ static configured policies.
Step 1. The UE may initiate disconnection of the PDN/NSWO connection by means of WLCP.
Step 2. The TWAN preferably releases the PDN connection and sends a Delete Session Request (Linked EPS Bearer ID) message for this PDN connection to the PDN GW. In case of a NSWO connection, the TWAN preferably releases this connection and the subsequent steps preferably do not apply.
Step 3. The PDN GW preferably informs the 3GPP AAA Server of the PDN disconnection.
Step 4. The PDN GW preferably deletes the IP CAN session associated with the UE and executes a PCEF-Initiated IP CAN Session Termination Procedure with the PCRF as specified in TS 23.203 [x].
Step 5. The PDN GW preferably acknowledges with a Delete Session Response (Cause) message.

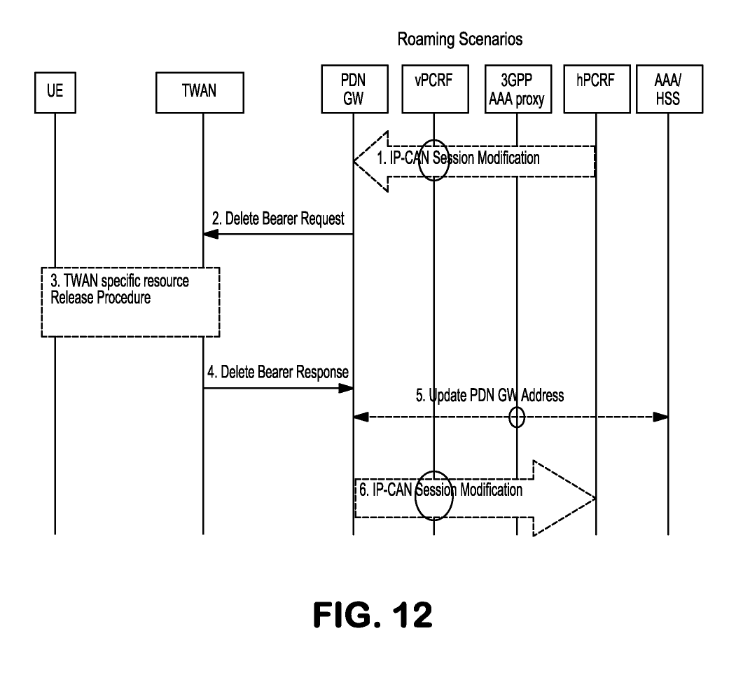

FIG. 12 is a process diagram of a PDN GW Initiated Bearer Resource Allocation Deactivation in WLAN with GTP on S2a. The procedure if FIG. 12 is preferably as in TS 23.402, clause 16.4.1 with the following difference: If all TWAN resources related to a PDN/NSWO connection are released, then in step 3 the UE is preferably informed of the PDN/NSWO release using WLCP.

The present invention can be realized in hardware, or a combination of hardware and software. Any kind of computing system, or other apparatus adapted for carrying out the methods described herein, is suited to perform the functions described herein. A typical combination of hardware and software could be a specialized computer system, e.g., a router, having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Computer readable medium means any non-transitory medium capable of storing program code which, when loaded into one or more processors, causes functions to be performed as described herein.

Thus, one embodiment is a computer readable medium containing computer readable instruction that, when executed by a processor, cause the processor to perform functions for maintaining clock synchronization between a first and a second radio.

All documents, specifications, clauses, etc. discussed herein are hereby incorporated into this disclosure by reference.

In addition, unless mention was made above to the contrary, it should be noted that all of the accompanying drawings are not to scale. It will be appreciated by persons skilled in the art that the present invention is not limited to what has been particularly shown and described herein above. A variety of modifications and variations are possible in light of the above teachings without departing from the scope and spirit of the invention, which is limited only by the following claims.

What is claimed is:

1. A method of providing, to a client, access to a plurality of Packet Data Networks (PDNs), each PDN providing a dedicated PDN connection, comprising the steps of:
assigning said client a plurality of virtual Media Access Control (MAC) addresses;
assigning each of said virtual MAC addresses to a dedicated PDN connection, each dedicated PDN connection being associated with one of said PDNs; and
providing to said client at least one of said virtual MAC addresses via a 4 address MAC frame for said client to communicate with the associated data service.

2. The method according to claim 1, wherein said client comprises a Wi-Fi client, and wherein said Wi-Fi client communicates with the associated data service over a cellular data network using the provided 4 address MAC frame.

3. The method according to claim 2, wherein the Wi-Fi client communicates with plural associated data services at the same time.

4. The method according to claim 2, wherein the communicating comprises providing an upstream 4 address MAC frame comprising:
a Receiver Address corresponding to an Access Point (AP) Basic Service Set Identifier (BSSID);
a Transmitter Address corresponding to a User Equipment (UE) MAC address1;
a Destination Address corresponding to a Trusted WLAN Access Gateway; and
a Source Address corresponding to a UE MAC address2.

5. The method according to claim 4, wherein the client has a first connection to a PDN, and wherein the UE MAC address2 comprises a virtual address corresponding to a second PDN connection.

6. The method according to claim 2, wherein the communicating comprises providing a downstream 4 address MAC frame comprising:
a Receiver Address corresponding to a UE MAC address1;
a Transmitter Address corresponding to an AP BSSID;
a Destination Address corresponding to a UE MAC address2; and
a Source Address corresponding to a Trusted WLAN Access Gateway.

7. The method according to claim 6, wherein the client has a first connection to a PDN, and wherein the UE MAC address2 comprises a virtual address corresponding to a second PDN connection.

8. The method according to claim 2, further comprising a second step of the client communicating with a second associated data service over the cellular data network using a second one of said virtual MAC addresses via a second 4 address MAC frame, and wherein the second step of communicating comprises providing an upstream 4 address MAC frame comprising:
a Receiver Address corresponding to an AP BSSID;
a Transmitter Address corresponding to a UE MAC address1;
a Destination Address corresponding to a Trusted WLAN Access Gateway; and
a Source Address corresponding to a UE MAC address3.

9. The method according to claim 8, wherein the client has a first connection to a PDN, and wherein the UE MAC address3 comprises a virtual address corresponding to another PDN connection.

10. The method according to claim 9, wherein the second step of communicating comprises providing a downstream 4 address MAC frame comprising:
a Receiver Address corresponding to a UE MAC address1;
a Transmitter Address corresponding to an AP BSSID;
a Destination Address corresponding to a UE MAC address3; and
a Source Address corresponding to a Trusted WLAN Access Gateway.

11. The method according to claim 10, wherein the client has a first connection to a PDN, and wherein the UE MAC address2 comprises a virtual address corresponding to another PDN connection.

12. The method according to claim 1, wherein said Wi-Fi client comprises a cellular telephone.

13. The method according to claim 1, wherein said Wi-Fi client comprises a pad device.

14. The method according to claim 1, wherein the virtual MAC addresses are provided to the client prior to said client contacting an access point.

15. The method according to claim 1, wherein the virtual MAC addresses are provided to the client after said client contacts an access point.

16. The method according to claim 1, wherein the virtual MAC addresses are provided to the client by a network during an authentication process.

17. The method according to claim 1, wherein the virtual MAC addresses are provided to the client by a negotiation during an address resolution negotiation.

18. The method according to claim 1, wherein the virtual MAC addresses provided to the client are stored in a client memory.

19. Apparatus providing to a client, access to a plurality of Packet Data Networks (PDNs), each PDN providing a dedicated PDN connection, comprising:
an Access Point (AP) configured to communicate with (i) the client and (ii) the plurality of PDNs, the AP further configured to:
assign said client a plurality of virtual Media Access Control (MAC) addresses;
assign each of said virtual MAC addresses to a dedicated PDN connection, each dedicated PDN connection being associated with one of said PDNs; and
provide to said client at least one of said virtual MAC addresses via a 4 address MAC frame for said client to communicate with the associated data service.

20. The apparatus according to claim 19, wherein said client comprises a Wi-Fi client, and wherein said Wi-Fi client communicates with the associated data service over a cellular data network using the provided 4 address MAC frame.

21. The apparatus according to claim 20, wherein the AP is further configured to provide the client an upstream 4 address MAC frame comprising:
a Receiver Address corresponding to an Access Point (AP) Basic Service Set Identifier (BSSID);
a Transmitter Address corresponding to a User Equipment (UE) MAC address1;
a Destination Address corresponding to a Trusted WLAN Access Gateway; and
a Source Address corresponding to a UE MAC address2.

22. The apparatus according to claim 21, wherein the client has a first connection to a PDN, and wherein the UE MAC address2 comprises a virtual address corresponding to a second PDN connection.

23. The apparatus according to claim 21, wherein the AP is further configured to provide the client a downstream 4 address MAC frame comprising:
a Receiver Address corresponding to a UE MAC address1;
a Transmitter Address corresponding to an AP BSSID;
a Destination Address corresponding to a UE MAC address2; and
a Source Address corresponding to a Trusted WLAN Access Gateway.

24. The apparatus according to claim 23, wherein the client has a first connection to a PDN, and wherein the UE MAC address2 comprises a virtual address corresponding to a second PDN connection.

25. The apparatus according to claim 19, wherein the AP is further configured to provide the client with a second one of said virtual MAC addresses via a second 4 address MAC frame for the client to communicate with another associated data service, and wherein the AP is further configured to provide to the client an upstream 4 address MAC frame comprising:
a Receiver Address corresponding to an AP BSSID;
a Transmitter Address corresponding to a UE MAC address1;
a Destination Address corresponding to a Trusted WLAN Access Gateway; and
a Source Address corresponding to a UE MAC address3.

26. The apparatus according to claim 25, wherein the client has a first connection to a PDN, and wherein the UE MAC address3 comprises a virtual address corresponding to another PDN connection.

27. The apparatus according to claim 26, wherein the AP is further configured to provide to the client a downstream 4 address MAC frame comprising:
a Receiver Address corresponding to a UE MAC address1;
a Transmitter Address corresponding to an AP BSSID;
a Destination Address corresponding to a UE MAC address3; and
a Source Address corresponding to a Trusted WLAN Access Gateway.

28. The apparatus according to claim 27, wherein the client has a first connection to a PDN, and wherein the UE MAC address2 comprises a virtual address corresponding to another PDN connection.

29. The apparatus according to claim 19, further comprising the Wi-Fi client, which comprises a cellular telephone.

30. At least one computer-readable, non-transitory medium containing program code which, when loaded into one or more processors of an Access Point (AP) causes said one or more processors to provide to a client access to a plurality of Packet Data Networks (PDNs), each PDN providing a dedicated PDN connection, said program code also causing said one or more processors to:
assign to said client a plurality of virtual Media Access Control (MAC) addresses;
assign each of said virtual MAC addresses to a dedicated PDN connection, each dedicated PDN connection being associated with one of said PDNs; and
provide to the client at least one of said virtual MAC addresses via a 4 address MAC frame when said client is communicating with the associated data service.

31. A cellular telephone, comprising:
transmitter and receiver structure configured to communicate with an access point;
a memory storing a plurality of virtual Media Access Control (MAC) addresses, each corresponding to a dedicated PDN connection; and
at least one processor configured to communicate with said access point, through said transmitter and receiver structure, using at least one of the stored virtual MAC addresses in a 4 address MAC frame.
